(19) United States
(12) Patent Application Publication
(10) Pub. No.: US 2025/0340754 A1
(43) Pub. Date: Nov. 6, 2025

(54) Insulation adhesive composition for insulation tape manufacturing, insulation tape, method for preparing insulation adhesive composition for insulation tape manufacturing, and method for manufacturing insulation tape

(71) Applicant: Tae Wan KIM, Daegu (KR)

(72) Inventor: Tae Wan KIM, Daegu (KR)

(21) Appl. No.: 18/868,175

(22) PCT Filed: Aug. 23, 2022
(86) PCT No.: PCT/KR2022/012575

§ 371 Date: Feb. 6, 2025

(30) Foreign Application Priority Data
May 24, 2022 (KR) 10-2022-0063300

(51) Int. Cl. C09J 7/20; C09J 9/00

(52) U.S. Cl. CPC C09J 7/20; C09J 9/00; C09J 2301/16

(57) ABSTRACT

A heat insulation adhesive composition for preparing a heat insulation tape, a heat insulation tape manufactured using the same, and methods for manufacturing a heat insulation tape and a heat insulation adhesive composition for preparing a heat insulation tape are disclosed. The present invention is implemented through processes of applying a heat insulation adhesive composition including a heat insulating hollow body and an adhesive binder to an upper surface of a base layer, and drying the heat insulation adhesive composition applied to the upper surface of the base layer. According to the present invention, a heat insulation tape is provided using the heat insulation adhesive composition for preparing a heat insulation tape, which allows a decrease in heat insulation performance due to loss of coating (applying) thickness during a drying process to be minimized.

### TECHNICAL FIELD

The present invention relates to a heat insulation tape, a heat insulation adhesive composition for preparing a heat insulation tape, and methods for manufacturing a heat insulation tape and a heat insulation adhesive composition for preparing a heat insulation tape, and more specifically, to a heat insulation adhesive composition for preparing a heat insulation tape, which allows a decrease in heat insulation performance due to loss of coating (applying) thickness during a drying process to be minimized, a heat insulation tape manufactured using the same, and methods for manufacturing a heat insulation tape and a heat insulation adhesive composition for preparing a heat insulation tape.

### BACKGROUND ART

Pipes or cables such as melting furnace operating equipment and exhaust manifold are subjected to heat insulation treatment by taping them with a tape-shaped heat insulation material. Accordingly, various types of heat insulation tapes are provided on the market, and for example, a silica tape woven with silica fibers is provided as an ultra-high temperature heat insulation tape.

Meanwhile, a heat insulating composition including hollow ceramic beads and a binder is widely used for preparation of heat insulation paint, but a heat insulation tape prepared using such the heat insulating composition as an adhesive has not yet been provided.

### SUMMARY OF INVENTION

### Problems to be Solved by Invention

Therefore, an object of the present invention is to provide a heat insulation adhesive composition for preparing a heat insulation tape, which allows a decrease in heat insulation performance due to loss of coating (applying) thickness during a drying process to be minimized, a heat insulation tape manufactured using the same, and methods for manufacturing a heat insulation tape and a heat insulation adhesive composition for preparing a heat insulation tape.

The problem to be solved by the present invention is not limited to the above-described problems, and may include other technical problems that can be clearly understood by those skilled in the art from the following description.

### Means for Solving Problems

To achieve the above object, according to an aspect of the present invention, there is provided a heat insulation adhesive composition for preparing a heat insulation tape includes a heat insulating hollow body; and an adhesive binder.

In addition, according to another aspect of the present invention, there is provided a method for manufacturing a heat insulation adhesive composition for preparing a heat insulation tape, which includes the steps of: (a) mixing a heat insulating hollow body and an adhesive binder; and (b) stirring a mixture of the heat insulating hollow body and the adhesive binder.

Further, according to another aspect of the present invention, there is provided a heat insulation tape including: a base layer; and a heat insulation adhesive composition applied to an upper surface of the base layer, wherein the heat insulation adhesive composition includes a heat insulating hollow body and an adhesive binder.

Furthermore, according to another aspect of the present invention, there is provided a method for manufacturing a heat insulation tape, which includes the steps of: (a) applying a heat insulation adhesive composition including a heat insulating hollow body and an adhesive binder to an upper surface of the base layer; and (b) drying the heat insulation adhesive composition applied to the upper surface of the base layer.

### Advantageous Effects

According to the present invention, there are provided a heat insulation adhesive composition for preparing a heat insulation tape, which allows a decrease in heat insulation performance due to loss of coating (applying) thickness during a drying process to be minimized, a heat insulation tape manufactured using the same, and methods for manufacturing the same, respectively.

The effect of the present invention is not limited to the above-described effects, and may include other effects that can be clearly understood by those skilled in the art from the following description.

### BRIEF DESCRIPTION OF DRAWINGS

FIG. 1 is a flowchart describing a method for manufacturing a heat insulation adhesive composition according to an embodiment of the present invention.

FIG. 2 is a flowchart describing a method for manufacturing a heat insulation tape according to an embodiment of the present invention.

FIG. 3 is a cross-sectional view illustrating a structure of the heat insulation tape according to an embodiment of the present invention.

FIG. 4 is a perspective view illustrating a structure of a stirring blade structure used in the method for manufacturing a heat insulation adhesive composition according to an embodiment of the present invention.

### MODE FOR CARRYING OUT INVENTION

Hereinafter, the present invention will be described with reference to the accompanying drawings in detail. Referring to the drawings, wherein like reference characters designate like or corresponding parts throughout the several views. In the embodiments of the present invention, the publicly known functions and configurations that are judged to be able to make the purport of the present invention unnecessarily obscure will not be described in detail.

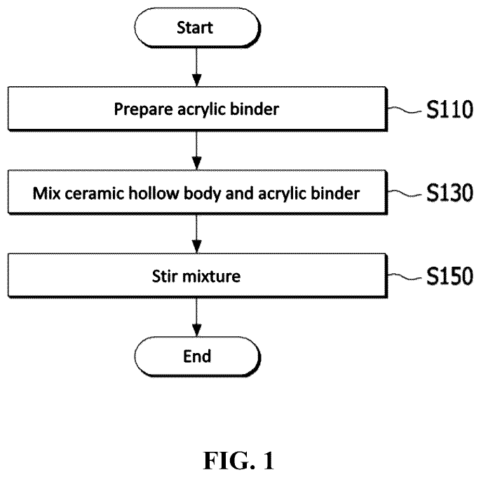

FIG. 1 is a flowchart describing a method for manufacturing a heat insulation adhesive composition according to an embodiment of the present invention. Hereinafter, the method for manufacturing a heat insulation adhesive composition according to an embodiment of the present invention will be described with reference to FIG. 1.

First, a manufacturer mixes 54 to 56 parts by weight of an acrylic copolymer and 44 to 46 parts by weight of water (distilled water or purified water, pH 7), and then stirs the mixture in a sealed container at a stirring speed of about 30 to 100 rpm for a long period of time (for example, 30 to 60 minutes) to prepare an acrylic binder as an adhesive binder (S110).

Thereafter, the manufacturer mixes 4 to 22 parts by weight of a ceramic hollow body (hollow ceramic beads), which is a heat insulating hollow body having excellent fire resistance and heat insulation efficiency, and 100 to 102 parts by weight of the acrylic binder manufactured in the above-described step S110, thus to prepare a mixture of the ceramic hollow body and the acrylic binder (S130), followed by stirring the mixture prepared as described above under the following stirring conditions, to prepare the heat insulation adhesive composition according to the present invention (S150).

The inventor of the present invention found a problem that when stirring a mixture using a stirring blade having a simple propeller structure generally used to stir the mixture in the above-described step S150, it appears that the stirring has been completed due to a vortex phenomenon caused by the rotational force of the stirring blade, even though sufficient stirring is not actually achieved.

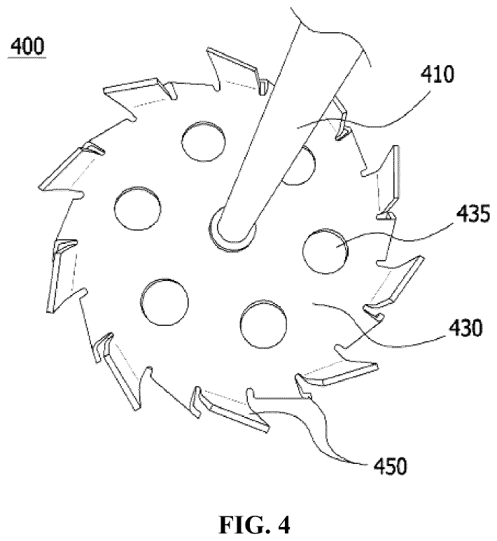

Accordingly, the inventor of the present invention has prepared a dispersion type stirring blade structure 400 as shown in FIG. 4 and used to stir the mixture, and consequently, confirmed that the ceramic hollow bodies are evenly distributed in the mixture despite a high viscosity of the acrylic binder.

Specifically, referring to FIG. 4, the stirring blade structure 400 used in the method for manufacturing a heat insulation adhesive composition according to an embodiment of the present invention includes a rotation shaft 410, a main body panel 430 and blade parts 450.

The rotation shaft 410 is fixedly installed at a center of the main body panel 430 having a disc-shaped structure so as to be orthogonal thereto, and the main body panel 430 has a plurality of stirring holes 435 formed therein at a constant interval along a circumference of the main body panel 430 at a constant distance from the rotation shaft 410.

Not only does vertical stirring between an upper space and a lower space of the main body panel 430 become possible through the plurality of stirring holes 435, but also a load applied to the main body panel 430 may be reduced, thereby decreasing the load on a motor for rotating the rotation shaft 410.

Meanwhile, some of the plurality of blade parts 450, which extend from an outer edge of the disc-shaped main body panel 430 and are continuously formed along the circumference of the disc-shaped main body panel 430 as a sawtooth-like structure, are bent upward to form an angle of +90° with the main body panel 430, and the remaining some of the plurality of blade parts 450 are bent downward to form an angle of −90° with the main body panel 430.

More specifically, it is preferable that the blade parts 450 having the upward-bent structure and the blade parts 450 having the downward-bent structure are sequentially formed by intersecting along the circumference of the disc-shaped main body panel 430.

When stirring the mixture using the stirring blade structure 400 having the structure as shown in FIG. 4, the generation of vortex in the mixture is minimized, and not only a large amount of fine-sized bubbles may be generated during stirring, but also physical stirring of the acrylic binder and the ceramic hollow body, which are materials not chemically mixed with each other, is very effectively performed.

Meanwhile, in carrying out the present invention, it is preferable that the disc-shaped main body panel 430 has a diameter of about 70 to 90% based on a diameter of the stirring vessel.

Specifically, if the diameter of the disc-shaped main body panel 430 is less than 70% based on the diameter of the stirring vessel, stirring is not sufficiently performed at a peripheral portion inside the vessel, and if the diameter of the disc-shaped main body panel 430 exceeds 90% based on the diameter of the stirring vessel, there is a problem of occurring an overload in the stirring motor.

In addition, in carrying out the present invention, it is preferable that a stirring speed of the mixture using the stirring blade structure 400 shown in FIG. 4 is 200 rpm to 700 rpm.

Specifically, if the stirring speed is less than 200 rpm, stirring is not substantially performed in an upper layer, such that the mixture is solidified, thereby resulting in a problem that upper and lower layers are separated, and if the stirring speed exceeds 700 rpm, there is a problem of decreasing the heat insulation performance due to an excessive increase of pores in the heat insulation adhesive composition caused by the generation of a large amount of bubbles having a relatively large size.

Meanwhile, in carrying out the present invention, the heat insulation adhesive composition prepared by the manufacturing method shown in FIG. 1 may be a pressure sensitive adhesive (PSA) composition.

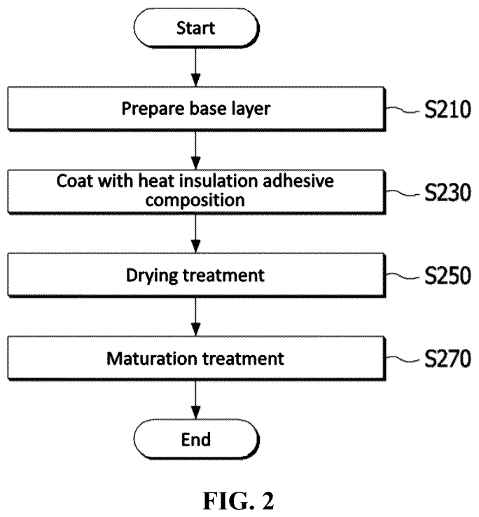

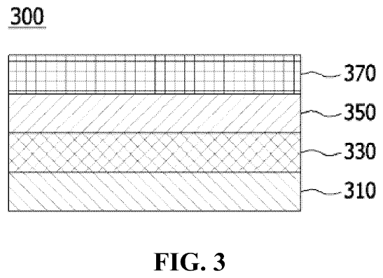

FIG. 2 is a flowchart describing a method for manufacturing a heat insulation tape according to an embodiment of the present invention, and FIG. 3 is a cross-sectional view illustrating a structure of the heat insulation tape according to an embodiment of the present invention.

Hereinafter, the method for manufacturing a heat insulation tape 300 according to an embodiment of the present invention will be described with reference to FIGS. 2 and 3.

First, the manufacturer prepares a base layer 310 necessary for manufacturing the heat insulation tape 300 by cutting the base layer 310 made of glass fiber, non-woven fabric, etc. to desired width and length (S210).

Meanwhile, in carrying out the present invention, the base layer 310 may be prepared by weaving the glass fiber (E-Glass) used as a membrane material and then performing waterproofing and flame retardant treatment as a pretreatment stage for coating treatment in step S230, which will be described below, on a lower surface and an upper surface, respectively.

Thereafter, the manufacturer performs coating treatment with the heat insulation adhesive composition by applying and spreading the heat insulation adhesive composition prepared in the above-described step S150 to the upper surface of the base layer 310 in a predetermined coating (application) thickness (for example, 1 mm) (S230).

In carrying out the present invention, the coating treatment of the heat insulation adhesive composition may be performed by a transfer coating method. In this regard, all methods including comma coating, knife coating, mesh coating, calendar coating, etc. may be used.

Then, the manufacturer performs a drying treatment on the heat insulation adhesive composition subjected to coating treatment (S250). In carrying out the present invention, it is preferable that the drying treatment on the heat insulation adhesive composition is performed by simultaneously carrying out the drying treatment by hot air and the drying treatment by infrared rays in a drying chamber for a predetermined reference time (for example, 5 to 10 minutes).

Specifically, in the case of an infrared and hot air mixing chamber composed of five drying sections, 80° C. hot air may be supplied to section 1, 100° C. hot air to section 2, 130° C. hot air to section 3, 120° C. hot air to section 4, and 120° C. hot air to section 5.

In addition, in the case of a drying chamber where hot air treatment sections and infrared treatment sections are separated, 80° C. hot air may be supplied to the section 1, 100° C. hot air to section 2, 120° C. infrared to section 3, 130° C. infrared to section 4, and 130° C. infrared to section 5.

Further, in the case of a chamber where upper and lower temperatures may be individually set, the temperatures may also be set so that section 1 is maintained at 80° C. for the upper portion and 100° C. for the lower portion, section 2 is maintained at 90° C. for the upper portion and 110° C. for the lower portion, section 3 is maintained at 110° C. for the upper portion and 130° C. for the lower portion, section 4 is maintained at 120° C. for the upper portion and 150° C. for the lower portion, and section 5 is maintained at 120° C. for the upper portion and 160° C. for the lower portion.

Meanwhile, since a large number of microbubbles are formed inside the heat insulation adhesive composition prepared through stirring treatment according to the stirring conditions in the above-described step S150, when a solid volume ratio (SVR) is 60% and the composition is applied in a thickness of 1 mm, even after performing the drying treatment as described above, the coating (application) thickness of the heat insulation adhesive composition is maintained at 0.7 to 0.9 mm, which is 70 to 90% of an initial coating (application) thickness, and through this, the heat insulation performance of the heat insulation adhesive composition may be maintained in a very good state.

Meanwhile, in the case of the heat insulation adhesive composition used in the prior art, if the solid volume ratio (SVR) is 60%, the thickness is usually maintained at 0.6 mm after drying treatment when the composition is applied in a thickness of 1 mm.

In addition, in carrying out the present invention, by additionally applying the pressure sensitive adhesive (PSA) composition to an upper portion of the heat insulation adhesive composition that has been subjected to drying treatment as described above, adhesion of the heat insulation tape according to the present invention may also be further increased.

Further, in carrying out the present invention, the drying treatment process in the above-described step S250 may also be additionally performed on a pressure sensitive adhesive composition that has been subjected to coating (application) treatment. Furthermore, in carrying out the present invention, after the coating treatment with the heat insulation adhesive composition, the pressure sensitive adhesive (PSA) composition is additionally applied without performing the drying treatment, and then the above-described drying treatment process may be performed integrally therewith.

Thereafter, the manufacturer may store the semi-finished product that has been subjected to drying treatment by the above-described method in a sealed space equipped with an internal air circulation system while maintaining the temperature at about 40 to 60° C. for about 48 hours, thereby performing maturation treatment on the heat insulation adhesive composition and the pressure sensitive adhesive composition that have been subjected to drying treatment (S270).

After performing the maturation treatment as described above, the manufacturer may attach a release film 370 to an upper surface of a heat insulation adhesive composition layer 330 or a pressure sensitive adhesive composition layer 350, thereby completing the preparation of the heat insulation tape 300 according to the present invention.

Terms used in the present invention are used only to describe specific embodiments, and are not intended to limit the present invention. Singular expressions used herein include plural expressions unless they have definitely opposite meanings in the context. In the present application, it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

While the present invention has been described with reference to the preferred embodiments and modified examples, the present invention is not limited to the above-described specific embodiments and the modified examples, and it will be understood by those skilled in the art that various modifications and variations may be made therein without departing from the scope of the present invention as defined by the appended claims, as well as these modifications and variations should not be understood separately from the technical idea and prospect of the present invention.

### INDUSTRIAL APPLICABILITY

The present invention may be applied to the technical field related to the heat insulation tape, such that industrial applicability thereof is recognized.

1. A heat insulation adhesive composition for preparing a heat insulation tape comprising:
a heat insulating hollow body; and
an adhesive binder.

2. A method for manufacturing a heat insulation adhesive composition for preparing a heat insulation tape, the method comprising the steps of:
(a) mixing a heat insulating hollow body and an adhesive binder; and
(b) stirring a mixture of the heat insulating hollow body and the adhesive binder.

3. A heat insulation tape comprising:
a base layer 310; and
a heat insulation adhesive composition applied to an upper surface of the base layer 310,
wherein the heat insulation adhesive composition comprises a heat insulating hollow body and an adhesive binder.

4. A method for manufacturing a heat insulation tape, the method comprising the steps of:
(a) applying a heat insulation adhesive composition comprising a heat insulating hollow body and an adhesive binder to an upper surface of a base layer 310; and
(b) drying the heat insulation adhesive composition applied to the upper surface of the base layer 310.
